(19) United States
(12) Patent Application Publication
(10) Pub. No.: US 2006/0047798 A1
(43) Pub. Date: Mar. 2, 2006

(54) System and method for automated capture, editing, replication, and deployment of server configurations

(76) Inventors: David A. Feinleib, Kirkland, WA (US); Brian K. Moran, Preston, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/891,356

(22) Filed: Jul. 13, 2004

(51) Int. Cl. G06F 15/173

(52) U.S. Cl. 709/223

(57) ABSTRACT

A system and method for the automated capture, editing, replication, and deployment of server configurations. The system includes a set of tools for creating system configurations; for editing configurations that are actively used on a server or stored but not in active use; for replicating configurations and allowing customization of one or more aspects of such configurations; and for deploying the same or modified configurations to various servers. The techniques used relate to lists indicating the location of configuration data, search mechanisms for finding configuration data, file editing methods, file send and retrieve methods, and user interface display methods for facilitating viewing, modification, archiving, and deployment of configuration by system administrators, as well as an online service used for the storage, search, retrieval, and discussion of configurations.

### FIELD OF THE INVENTION

The field of invention relates generally to a system and method for computer system configuration capture, editing, replication, and deployment, and more specifically but not exclusively relates to software, tools, and online services for controlling, managing, and processing such configurations.

### BACKGROUND INFORMATION

It can be appreciated that computer servers are commonly used for the storage of data, for the sharing of such data and of other resources such as printers, as well as for the storage and management of directory information and for authenticating users. Due to the number of such servers and the complexity of the software running on them, system administrators are trained in the skills required for on-going management and administration of such servers and the associated software.

These servers, by their nature, require system administrators to perform a number of repetitive tasks, including but not limited to the initial setup of such servers, which includes the installation and configuration of the operating system, such as “Red Hat Linux Enterprise Edition AS 3,” the installation and configuration of drivers, and the configuration of basic services, including but not limited to the configuration of file sharing services, printing and print sharing, and network, directory, and authentication services. Administrators must also perform on-going re-configuration of these servers, such as adding and removing users, creating file shares, configuring permissions, etc. The result of these administrative tasks are diverse and numerous configurations, with configuration data stored on the system in some persistent state so that if the system is restarted the configuration can be read by the operating system and/or application software.

As a result, companies have developed various commercial software products and system administrators have created custom scripts and programs for assisting with the administration of such servers. Most commercial software products lend themselves to being used repeatedly and on an on-going basis, while most scripts and programs developed by system administrators are often used once and then never reused due to the difficulty of maintaining such programs.

Until recently, the commonly used operating systems fell into two main categories: those that were members of the Windows family of operating systems such as “Windows NT 4,” and those that were members of the UNIX family of operating systems, such as “HP-UX” and “Solaris.” Because both of these operating systems have been in existence for a number of years, the operating systems themselves have matured and a number of tools have been developed to assist in the configuration of these systems.

More recently, the Linux operating system, such as “Red Hat Linux Enterprise Edition AS 3,” has grown in usage, especially in enterprise server environments. Due to the more recent evolution of the Linux operating system, the operating system itself is less mature and few if any commercial software management products are available. Those that are available are restricted to the passive monitoring of such systems. A category of tools that is much needed but has not yet been developed or matured are those that relate to the active management of such systems.

Active management tasks, including, but not limited to, the initial setup and configuration of servers and operating systems, the backup of server configuration data, and the addition and deletion of file shares are time consuming, labor-intensive, and error-prone.

In addition to the core challenge of automating such tasks, administrators face a number of related problems. One problem is that administrators familiar with one user interface for managing a particular system, such as the Microsoft Management Console application commonly used on Windows servers, are often not familiar with the interface for managing another system. As a result, Windows Administrators, for example, face significant difficulty managing Linux systems. For example, Windows administrators are used to the graphical management tools present on Windows systems, while Linux systems are commonly administered through text based configuration or “.conf” files, such as the “smb.conf” file used to configure the “Samba” file and print sharing program. It is hard for these administrators to configure and administer Linux servers, difficult for them to backup and restore configurations once created, and problematic to deploy existing configurations to new machines.

Another problem is that administrators must often create many similar but slightly different configurations. For example, an administrator in a large enterprise might be required to setup and configure 100 file and print servers. Without proper tools, the administrator would have to setup and configure each machine from scratch, installing the operating system, installing drivers, configuring file services, creating file shares, etc.

An additional problem is that while machines have become more reliable, failures still occur, and moreover, the need for disaster recovery solutions has become paramount. But administrators face the challenge that critical configuration information is stored in a variety of locations and formats on any given system, making such configuration data difficult to backup and restore in a reliable and efficient manner.

The present invention addresses the aforementioned problems that have developed due to the recent adoption of the Linux operating system. It provides a novel system and method for the automated capture, editing, replication, and deployment of server configurations.

### SUMMARY OF THE INVENTION

In accordance with aspects of the present invention, systems and methods are disclosed that address the foregoing computer system administration problems through a variety of unique configuration capture, editing, replication, and deployment techniques. The software described includes a set of tools for creating system configurations; for editing configuration that is actively used on a server or stored but not in active use; for replicating configurations and allowing customization of one or more aspects of such configurations; and for deploying the same or modified configurations to various servers. The techniques used relate to lists indicating the location of configuration data, search mechanisms for finding configuration data, file editing methods, file send and retrieve methods, and user interface display methods for facilitating viewing, modification, archiving, and deployment of configuration by system administrators.

The present invention relates to seven key areas, those of retrieval and storage of configurations; editing of configurations; deployment of configurations with or without modification; predefined configurations; a configuration repository; an online service component for configuration storage, retrieval, sharing, and transfer; and a unique access method allowing for use of the aforementioned aspects of the present invention from a variety of user interfaces and operating system platforms.

According to one set of techniques, the user installs and runs an innovative snap-in in the Microsoft Management Console (MMC) on a Windows system. The snap-in receives a request from the user through its user interface to retrieve the configuration of a specified Linux server. This snap-in communicates over a network with an innovative daemon, e.g. a computer program, running on a given Linux server, requesting that the configuration be retrieved. The daemon uses a combination of configuration location lists and disk search techniques to find the configuration data associated with the configuration. It compresses the data into a single file, generates a description of the configuration, which is pre-pended to the compressed configuration file, and sends the complete configuration file to the requesting snap-in. According to one set of techniques, the configuration file is stored in a directory or database on the Linux server. According to another set of techniques, the snap-in stores the configuration file on the Windows server in a directory or in a database.

According to another set of techniques, a novel Configuration Editor allows the user to edit a stored configuration. If the configuration is not present on the local system, it is retrieved from a specified server. The Configuration Editor modifies the locally stored configuration, allowing the user to modify a configuration as if it were present on a live server. The Configuration Editor provides a local simulation environment allowing the user to test the specified configuration prior to deployment. The Configuration Editor can store the modified configuration, deploy it to the original server from which it came, or deploy it to a different server.

According to another set of techniques, a Configuration Deployment Wizard prompts the user for one or more servers to which to deploy a specified configuration. As part of the pre-deployment process, the Configuration Deployment Wizard allows the user to adjust one or more settings associated with the configuration. For example, when deploying a new file and print server, the Configuration Deployment Wizard allows the user to specify the server name. Alternatively, the Configuration Deployment Wizard allows the user to specify a text file containing a list of server names, which are read by the Configuration Deployment Wizard and substituted as appropriate for each machine deployed.

According to another set of techniques, a Configuration Repository retrieves configurations from selected servers. It also acts as a forum, allowing system administrators to share configurations with each other, publicly, or within specified groups. The Configuration Repository permits saving, searching for, and retrieving configurations via a number of user interfaces.

According to a related set of techniques, the Configuration Repository provides the basis for a Configuration Online Service, an Internet site that provides global storage and sharing of configurations. The Configuration Online Service includes account and billing capabilities and allows a user to sign up for an account, and to receive varying storage amounts and features depending on the type of service the user signs up for.

According to another set of techniques, the present invention includes a set of predefined configurations. FIG. 13 illustrates an exemplary XML fragment of a pre-defined configuration, in which the configuration for a File Server is defined using the Extensible Markup Language (XML). The Configuration Editor presents these configurations to the user and they can be deployed as is or can be modified and then deployed. The pre-defined configurations include but are not limited to configurations for file and print servers and services, network services and servers providing network services, authentication services and servers providing authentication services, and web services and servers providing web services. In one embodiment, pre-defined configurations consist of one or more compressed configuration files with a description file pre-pended.

Advantageously, the present invention allows access to all configuration management techniques described through a variety of user interfaces, including, but not limited to, a web browser, a snap-in installed in the Microsoft Management Console (MMC) management framework program on Windows Servers, and an application running in the X-Windows graphical user interface on Linux.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a flowchart illustrating a configuration retrieval process, according to one embodiment of the invention.

FIG. 2 is a schematic drawing showing various components corresponding to one embodiment of an end-to-end configuration management system.

FIG. 3 shows the GetConfigurations command as written in Extensible Markup Language (XML).

FIG. 4 is a flowchart illustrating a configuration editing process, according to one embodiment of the invention.

FIG. 5 is a flowchart showing a configuration deployment process, according to one embodiment of the invention.

FIG. 6 is a flowchart illustrating the process of saving a configuration to a configuration repository, according to one embodiment of the invention.

FIG. 7 is a flowchart illustrating a process of viewing and retrieving configurations from a configuration repository, according to one embodiment of the invention.

FIG. 8 is a flowchart that illustrates a configuration search process enabled by a configuration repository, according to one embodiment of the invention.

FIG. 9 is a flowchart illustrating a process implemented by the online configuration service, according to one embodiment of the invention.

FIG. 10 is a schematic diagram illustrating various components used by the online configuration service process flow illustrated in FIG. 9.

FIG. 11 illustrates an exemplary configuration relationship tree.

FIG. 12 is a flowchart illustrating a process flow implemented by one embodiment of the present invention to display the relationship tree shown in FIG. 11.

FIG. 13 shows an exemplary XML fragment of a configuration.

FIG. 14 is a schematic diagram of an exemplary computer system that may be used to practice embodiments of the invention.

### DETAILED DESCRIPTION

Embodiments of method and apparatus for computer system configuration abstraction interface are described herein. In the following description, numerous specific details are set forth (such as the Perl scripting language) to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

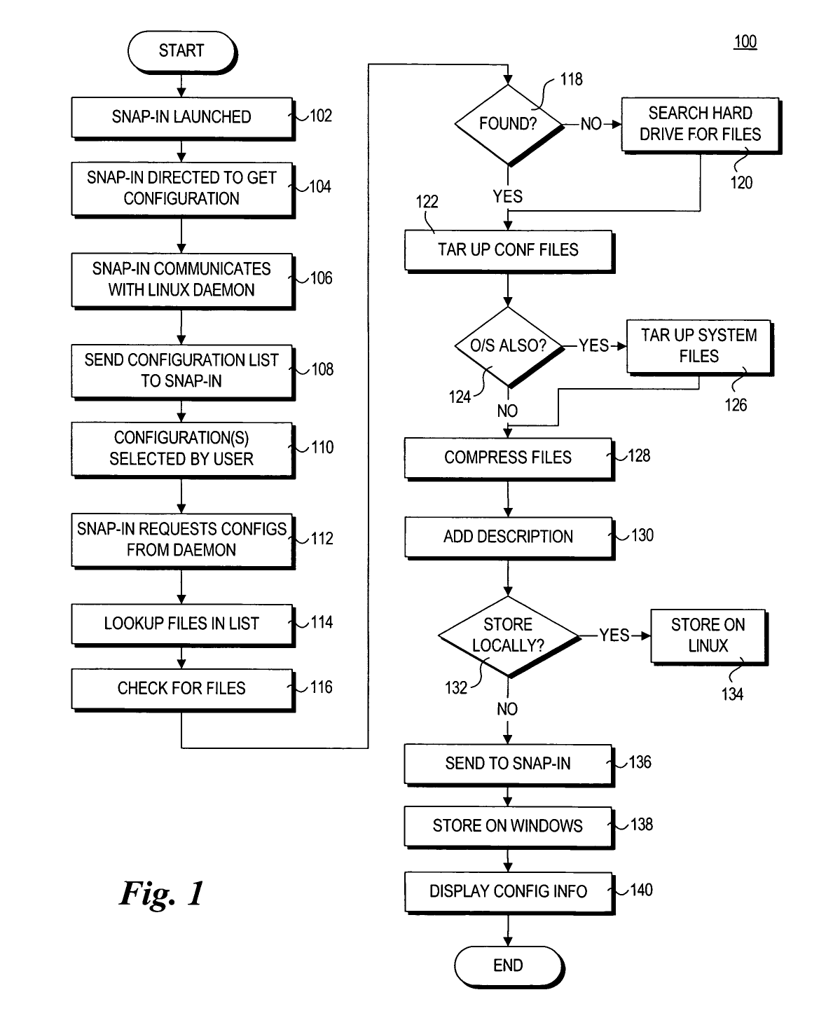

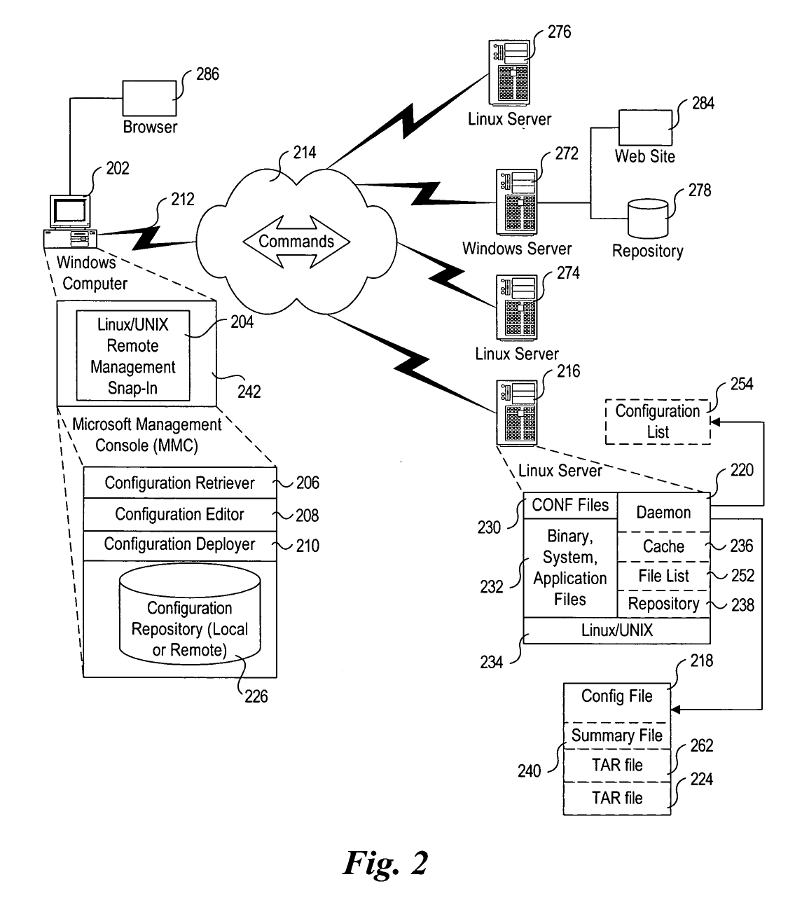

In FIG. 1, a novel process flow 100 for retrieving configuration information is shown, while FIG. 2 depicts various components in a system architecture that may be employed to perform the operations of process flow 100. In one embodiment, the system is implemented via a Snap-In 204 shown in FIG. 2, which runs inside a Microsoft Management Console 242 on computer a 202 running a version of the Windows operating system. Once loaded in a block 102, Snap-In 204 displays its user interface, which consists of various windows and controls. In a block 104, Snap-In 204 is directed by the user to retrieve configuration information from a specified server 216 running a version of the Linux operating system. In one embodiment, Snap-In 204 presents a menu to the user, and the user selects the “Retrieve Configuration,” menu item. If Snap-In 204 has not already connected to a Linux Daemon 220, Snap-In 204 displays a window in which the user may enter the name or Internet Protocol (IP) address of the server from which the configuration information is to be retrieved.

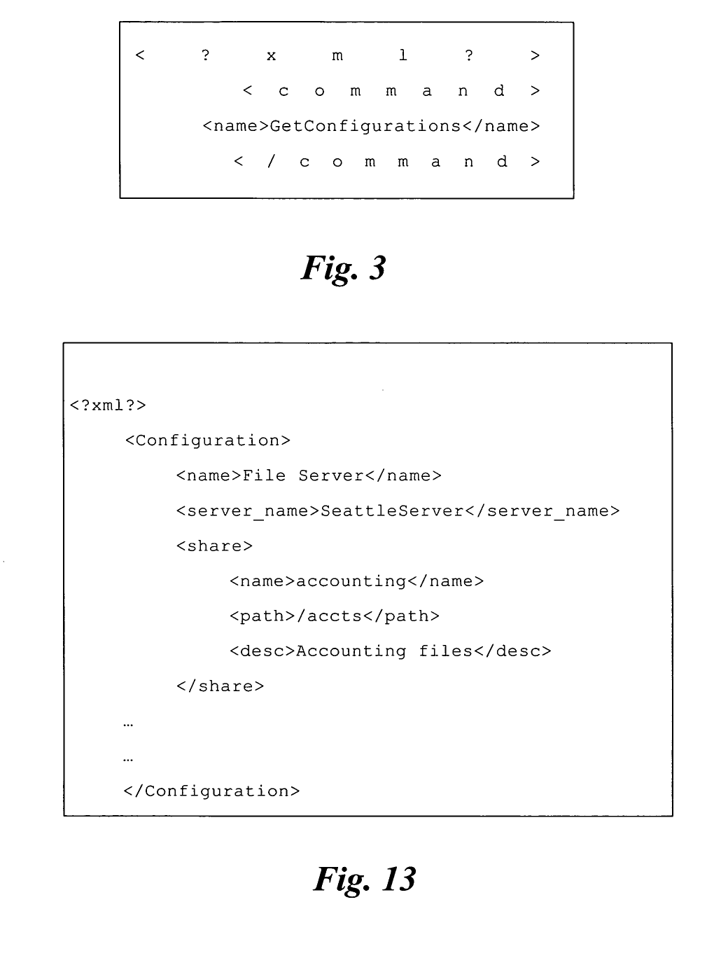

Once Snap-In 204 has received the name or IP address of the server to connect to, server 216, Snap-In 204 uses the Transmission Control Protocol over Internet Protocol (TCP/IP) over a link 212 and a network 214 to connect to daemon 220, running on Linux server 216 in a block 106, requesting a list of available configurations to be retrieved. In one embodiment, this request is formatted using Extensible Markup Language (XML), as shown in FIG. 3. It should be noted that Snap-In 204 and daemon 220 support the ability to authenticate the user requesting the configuration information, and also support encrypted communication. In one embodiment, the Secure Sockets Layer (SSL) is used to encrypt communication between Snap-In 204 and daemon 220.

In one embodiment, daemon 220 inspects Linux system 216 to determine what services are configured for which Daemon 220 can return configurations. Daemon 220 first looks in a Configuration Cache 236 to determine which services have previously been configured. In another embodiment, Daemon 220 evaluates the services currently running on server 216 to determine which ones are configured. In yet another embodiment, Daemon 220 recursively searches the hard drive of server 216 looking for configuration files; based on these files it determines which services are configured on the system. In yet another embodiment, Daemon 220 uses the “rpm” command to determine which services are installed on server 216. The rpm command, when run with the proper parameters, returns a list of modules installed on the server; Daemon 220 then filters this list to determine which services may be configured on the system.

Using one or more of the aforementioned techniques, Daemon 220 creates Configuration List 254, which it sends to Snap-In over network 214, as depicted in a block 108. In one embodiment, Configuration List 254 is created in Extensible Markup Language (XML) format. Based on Configuration List 254, Snap-In 204 displays a list of configurations that can be retrieved from the specified server in a block 110. In one embodiment, Snap-In 204 allows the user to select one or more configurations, using checkboxes that are displayed next to each configuration item in the list.

When directed by the user, Snap-In 204 requests the specified configurations from Daemon 220 over link 212 and network 214, as depicted in a block 112. When Daemon 220 receives the request, it looks up the configuration files associated with the specified configurations in File List 236 in a block 114. For example, if Snap-In 204 has requested to retrieve the configuration for file sharing services, Daemon 220 searches File List 236 for the file and print sharing services section. Then, for each file listed in that section, Daemon 220 looks for the specified file where it expects to find that file. That is, another section of File List 236 lists the default locations where all files specified in File List 236 are found. As depicted by a decision block 118, if a file is not found in the default location, Daemon 220 searches the hard drive for the specified file in a block 120. If files are not found, Daemon 220 handles that through an error handling process. If the files are found, Daemon 220 uses the “tar” command to store the specified configuration files 230 in a single TAR file 224 in a block 122. Based on the settings of Snap-In 204, Daemon 220 determines whether to retrieve the system files associated with a given configuration, as depicted by a decision block 124. That is, in addition to configuration files 230, if specified, Daemon 220 looks in File List 236 or uses the “rpm” command to determine the binary, system, and other files 232 associated with a given service. It then uses the “tar” command to store those files in TAR file 262 in a block 126.

After storing all appropriate files in TAR files 224 and/or 262, Daemon 130 compresses the files using a Run Length Encoding (RLE) algorithm in a block 128. In a block 130, Daemon 220 adds a Summary File 240 to the TAR file(s). Summary File 240 contains information that includes, but is not limited to, the name of server 216, the IP address of server 216, and the versions of modules running on Linux operating system 234.

At a decision block 132, based on the settings specified in Snap-In 204, Daemon 220 determines whether to store the resulting Configuration File 218 locally or to send it directly to Snap-In 204. In one embodiment, if the settings indicate that the Configuration File should be stored locally, Daemon 220 stores Configuration File 218 in Repository 238, a database used to store configuration files, as depicted in a block 134. In another embodiment, Daemon 220 stores Configuration File 218 in a directory in the file system on Server 216. Then, in a block 136, Daemon 220 sends Configuration File 218 to Snap-In 204 over network 214. Configuration Retriever 206, a component of Snap-In 204, receives Configuration File 218. In one embodiment, Configuration Retriever 206 stores Configuration File 218 in the file system of computer 202; in another embodiment, Configuration Retriever 206 stores Configuration File 218 in Configuration Repository 226, which is located either locally on computer 202, or remotely, on another server, such as Windows Server 272. This option is depicted in a block 138.

With the configuration now stored, Snap-In 204 displays the retrieved configuration information in a block 140. This completes the configuration retrieval, storage, and display process 100.

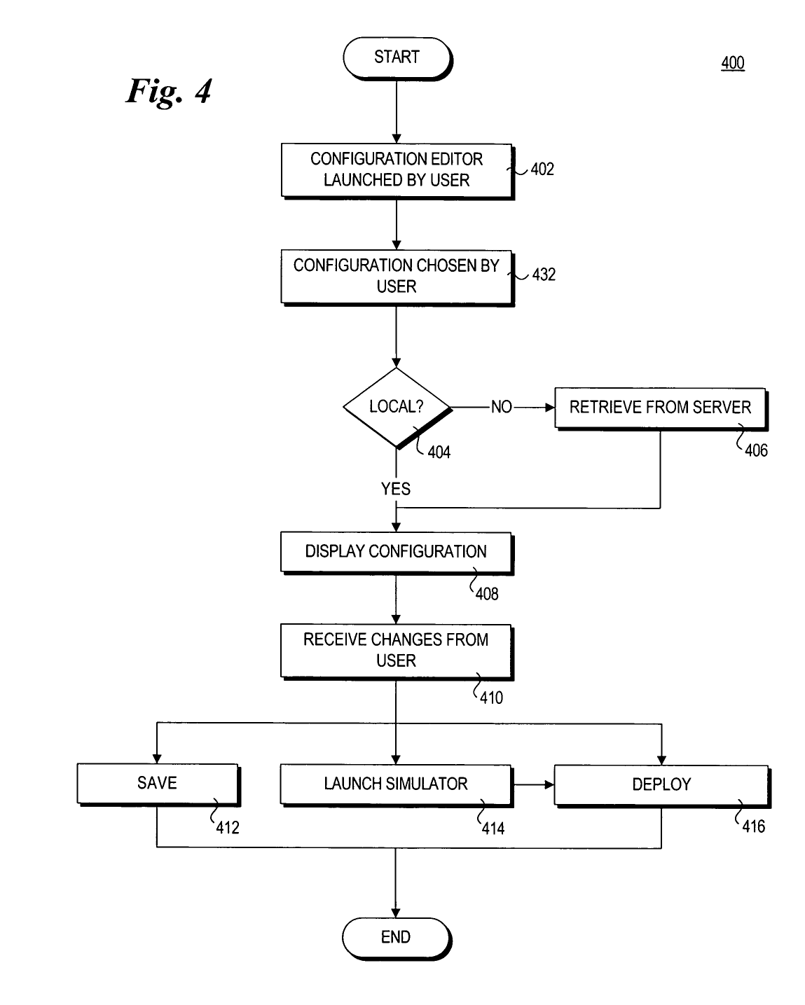

As shown in FIG. 4, process flow 400 permits configuration editing by the user. Configuration Editor 208 running on Windows computer 202 is launched by the user in a block 402. In one embodiment, Configuration Editor 208 runs as a Snap-in 204 inside Microsoft Management Console 242. In another embodiment, Configuration Editor 208 runs as a stand-alone application.

In a block 432, Configuration Editor 208 presents a list of configurations to the user. In general, such configurations can be local on computer 202, stored in repository 226, or stored in remote repository 238. In a block 432, the Configuration Editor receives the configuration selection of the user. As depicted by a decision block 404, if the configuration is not stored locally, Configuration Editor 208 retrieves the configuration over network 214 from wherever it is stored, such as remote repository 238 on server 216, in a block 406.

Configuration Editor 208 then displays the configuration to the user via its user interface, in one embodiment snap-in 204, in a block 408. It should be noted that while the configuration may be stored in the form of various configuration .CONF files, the display of such a configuration is not as simple as displaying the contents of the configuration files on-screen. Rather, Configuration Editor 208 uses a variety of windows, controls, and other mechanisms, including, but not limited to, treeview controls and listboxes to display and permit editing of the configuration.

In a block 410, Configuration Editor 410 receives configuration changes from the user via the aforementioned user interface. Configuration Editor 208 permits the user to save the modified configuration in a block 412, launch a simulation environment in a block 414, or deploy the modified configuration to a server such as Linux server 216 in a block 416. In one embodiment, the simulation environment consists of a virtual machine, that is, a computer system emulator implemented in software, such as “VMWare Workstation,” or “Microsoft Virtual PC 2004.” The simulator is loaded, and then Configuration Editor 410 deploys the configuration to the emulator environment in a block 416.

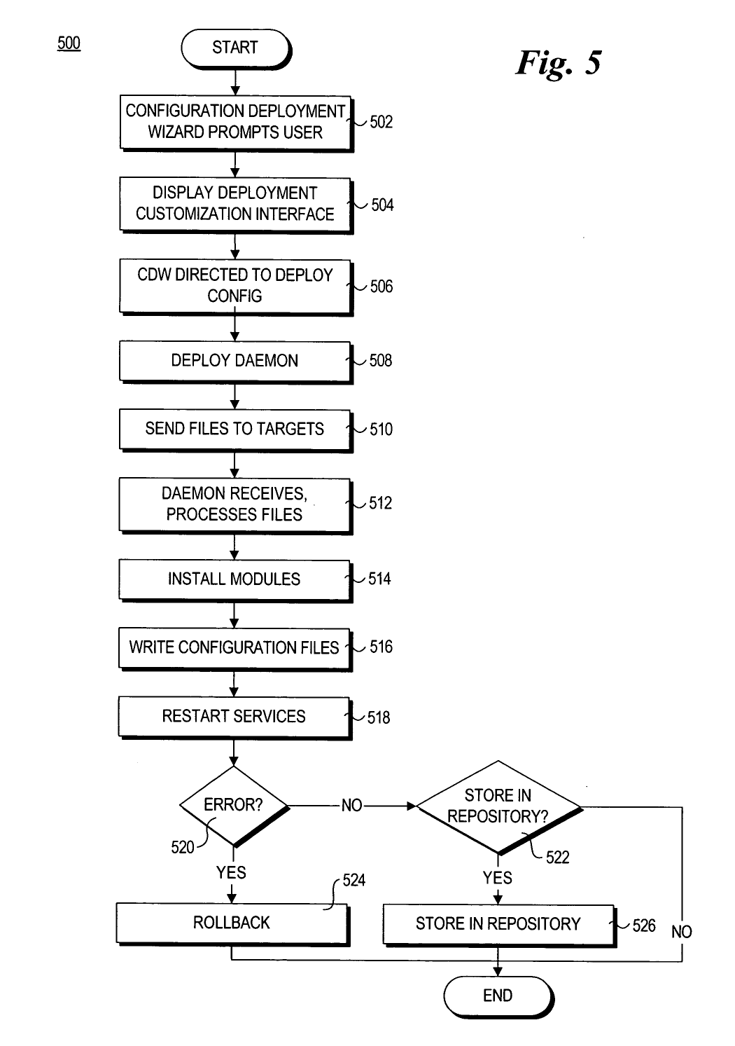

In FIG. 5, process flow 500 illustrates a process for deploying configurations to target servers. In a block 502, Configuration Deployment Wizard 210 displays a user interface to the user, which consists of a series of windows prompting the user for information about a configuration deployment. In particular, Configuration Wizard 210 prompts the user for information about which configuration to deploy, and which servers to deploy it to. As part of block 502, Configuration Wizard 210 browses the network to determine which Linux servers are available and presents those in a list to the user. In addition, Configuration Wizard 210 allows the user to type in the names or Internet Protocol (IP) addresses of one or more target servers.

During the wizard screen sequence, Configuration Wizard 210 also displays a deployment customization interface in a block 504; that is, a series of screens in which the user can modify the configuration to be deployed. Configuration Wizard 210 allows the user to modify settings including but not limited to the machine name and IP address. Configuration Wizard 210 can also read configuration change information from a text file or Excel spreadsheet.

In a block 506, Configuration Wizard 210 is directed to deploy the configuration, with any specified modifications, to one or more target Linux servers 216 and 274. Configuration Wizard 210 then contacts target servers 216 and 274; if it finds that Daemon 220 is not running on those servers, it deploys Daemon 220 to the servers in a block 508 using the remote shell (rsh) program, and appropriate user name and password credentials. Configuration Wizard 210 then communicates with Daemon 220 and transmits the files that make up the specified configuration, over network 214, using the TCP/IP protocol, in a block 510.

The process continues in a block 512, wherein Daemon 220 receives the configuration files. Daemon 220 determines if the specified configuration has any dependencies on operating system or application components that are not present on the system. If it determines that necessary components are not present, it installs those components from CD-ROM media or a server on network 214 in a block 514. Having completed the operating system module installation process, Daemon 220 writes the received configuration files to disk, in a block 516, and restarts any services that were affected by the configuration change in a block 518. Daemon 220 logs any changes made as it makes changes to the system.

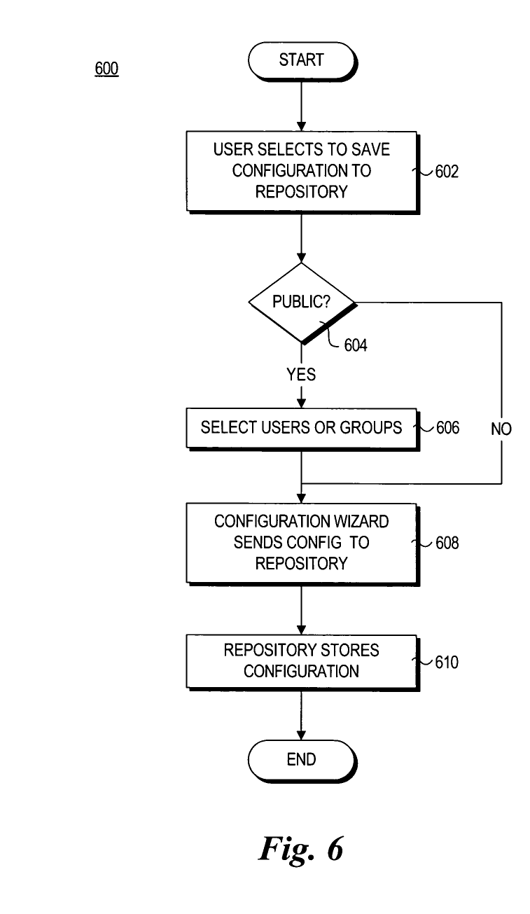

If at any time during process 500, Daemon 220 determines that an error has occurred, as depicted by a decision block 520, Daemon 220 rolls back the configuration changes in block 524. If no errors are encountered, the process continues to a decision block 522, wherein a determination is made to whether the user has specified the deployed configuration to be stored in a repository. If this is the case, Daemon 220 stores the deployed configuration in an external repository 278 in a block 526; otherwise, block 526 is skipped. This process is illustrated in more detail in the process flow 600 of FIG. 6, as follows

First, interacting with the user interface presented by Configuration Wizard 210, the user selects to save a configuration to repository 278 in a block 602. In response, Configuration Wizard 210 prompts the user to determine the specified configuration should be stored publicly, that is accessible to any user, or to only a select group of users, as depicted by a decision block 604. If the user does not want to store the configuration publicly, the user selects one or more users or groups who will have access to the specified configuration, as shown in a block 606. Configuration Wizard 210 then sends the configuration, in a block 608, as a stand-alone operation, or as part of deployment process 500, to repository 278. In one embodiment, repository 278 is implemented using the Microsoft SQL Server 2000 database, and configured using a database and associated tables designed to permit the storage and retrieval of configurations and associated information. Configuration Wizard 210 uses Open Database Connectivity (ODBC) function calls to interface with the database. In another embodiment, repository 278 is a software program running on computer 272 that receives configurations and allows for their retrieval, storing these configurations in the file system of the Windows operating system running on server 272. Repository 278 then stores the received configuration in a block 610.

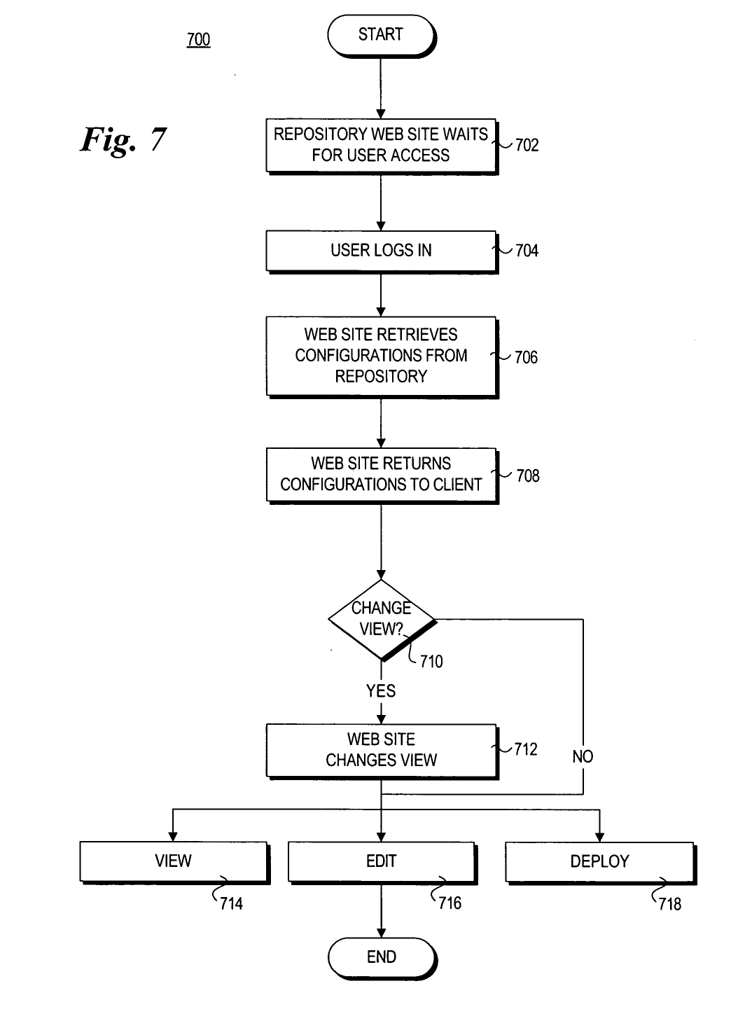

As illustrated by FIG. 7, process flow 700, Configuration Repository 278 permits the retrieval of configurations by the user. In one embodiment, web site 284, which consists of a number of pages written in the Hypertext Markup Language (HTML) and Active Server Pages (ASP), served by Internet Information Server (IIS), a web server, interfaces with repository 278. In a block 202, Web site 284 waits for a connection from a client computer, such as computer 202. The user logs in to web site 284 by launching Internet Explorer web browser 286 on computer 202. Browser 286 connects to web site 284 running on server 272, presenting a user log in interface returned to browser 286 by web site 284. In a block 704, the user enters username and password information, which is then authenticated by web site 284. In one embodiment, usernames and passwords are stored in repository 278 and web site 284 validates that the received username and password match a username and password combination that exists in repository 278. In another embodiment, web site 284 validates against an operating system provided database of username/password combinations. In yet another embodiment, web site 284 validates against another server on the network running Active Directory and the Kerberos authentication protocols. If the user cannot be validated, an error is returned to browser 286 allowing the user to attempt the login again (not shown).

If the login is successful, web site 284 retrieves configurations from repository 278 in a block 706. In one embodiment, Active Server Pages in web site 284 use ODBC calls to retrieve configurations and their descriptions from repository 278. In a block 708, web site 284 returns the found configurations to browser 286. Through the interface displayed in browser 286, the user has the ability to change view in the web site, as depicted by a decision block 710. For example, the view can be change to filter by configuration name or to view raw configuration files. If the user selects this option, the web site changes the view displayed. In one embodiment, the view is changed via Javascript scripting code embedded in the web pages. In another embodiment, the view is changed by communicating with web site 284 and returning the modified view over network 214 to browser 286, as shown by a block 712. Regardless of whether the user changes the view, the user can proceed to view the configurations in a block 714, edit configurations in a block 716, or deploy configurations in a block 718, using other aspects of the present invention.

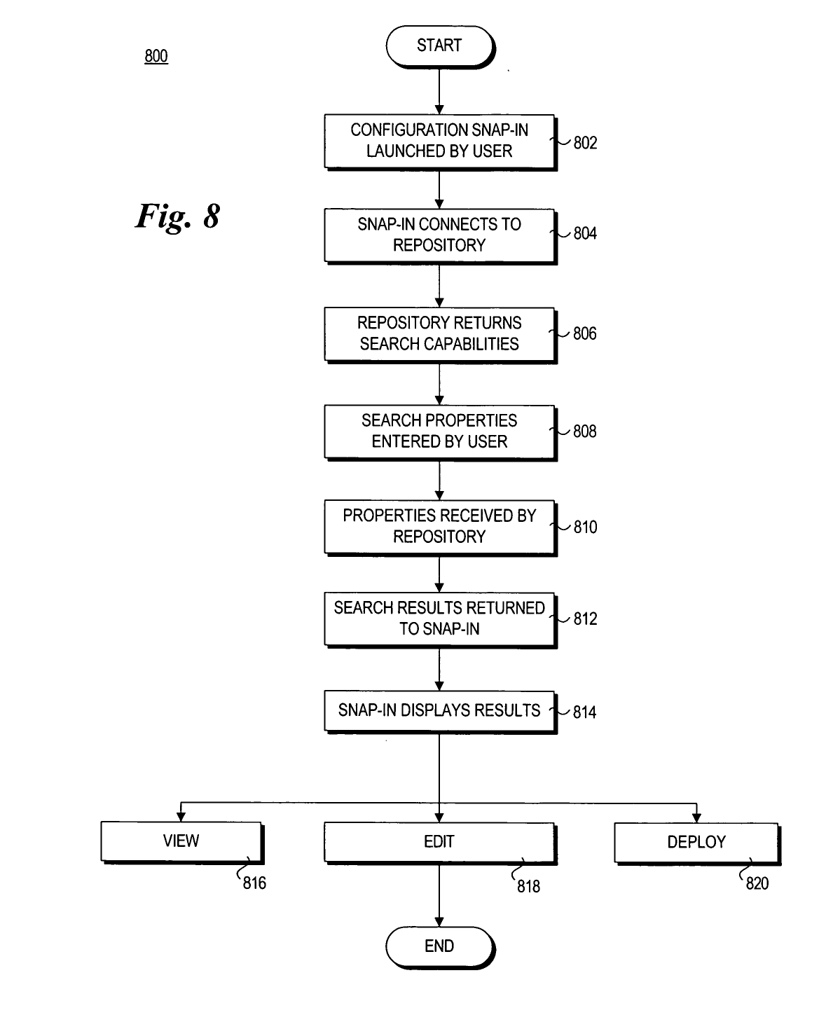

In FIG. 8, process flow 800 illustrates one embodiment of a search process supported by repository 278. In one embodiment, configuration Snap-in 204 is launched by the user in a block 802, and, based on stored repository location information or input by the user, connects to repository 278 over network 214, as depicted in a block 804. Snap-in 204 requests from repository 278 the search capabilities of repository 278, that is, the parameters that can be used to search the repository for stored configurations, such as keyword, date, system, size, etc. Repository 278 then returns these search capabilities to snap-in 204 over network 214 in a block 806. In a block 808, Snap-in 204 presents an interface to the user, using various edit and list windowing controls, into which the user enters the desired search properties. Snap-in 204 then transmits these search properties to repository 278 over network 214, which are received by repository 278 in a block 810, which then searches for stored configurations matching the search parameters received. In a block 812, repository 278 returns matching configuration names and descriptions to Snap-in 204. Snap-in 204 then displays the returned configuration names and descriptions in its user interface in accordance with a block 814. Based on the configurations displayed, the user can then, via the user interface of snap-in 204, view configurations in a block 816, edit configurations in a block 818, or deploy configurations in a block 820, using other aspects of the present invention.

In another embodiment, snap-in 204 is launched by the user, and configuration retrieval follows a flow similar to process 700; however, snap-in 204 communicates directly with repository 278 to retrieve and display configurations. Snap-in 204 permits the same view changes, in block 710, with modified views displayed in snap-in 204.

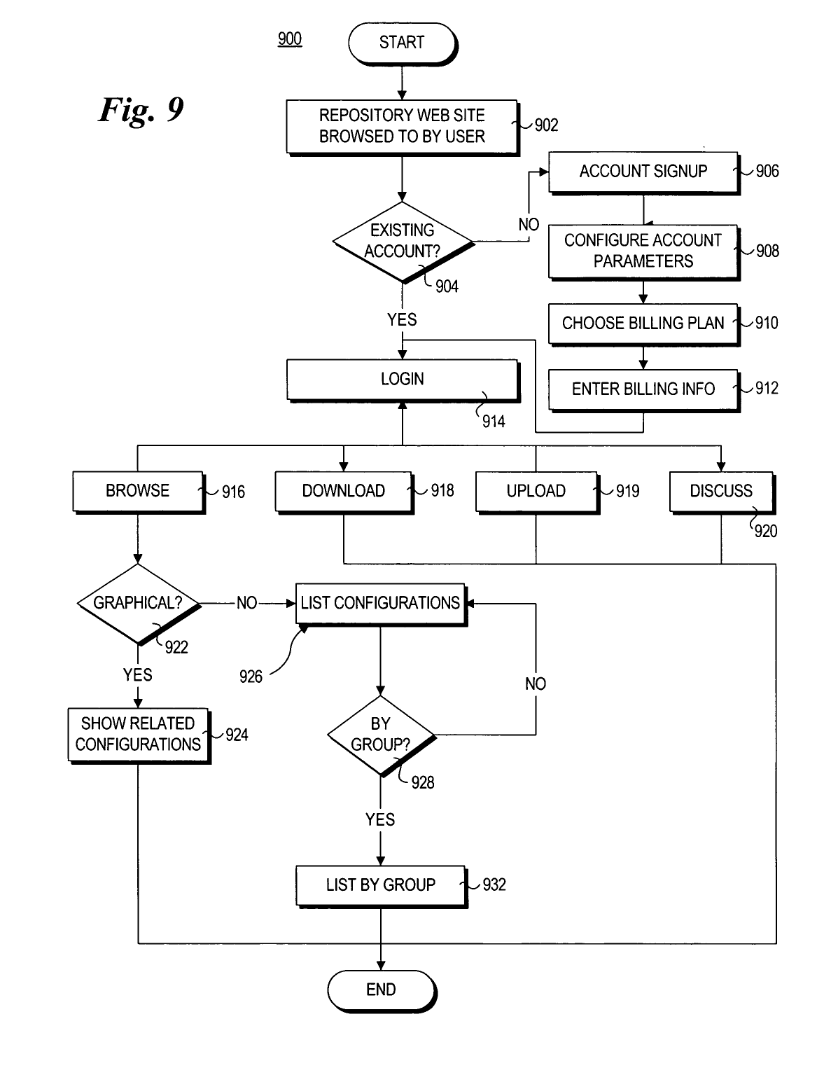

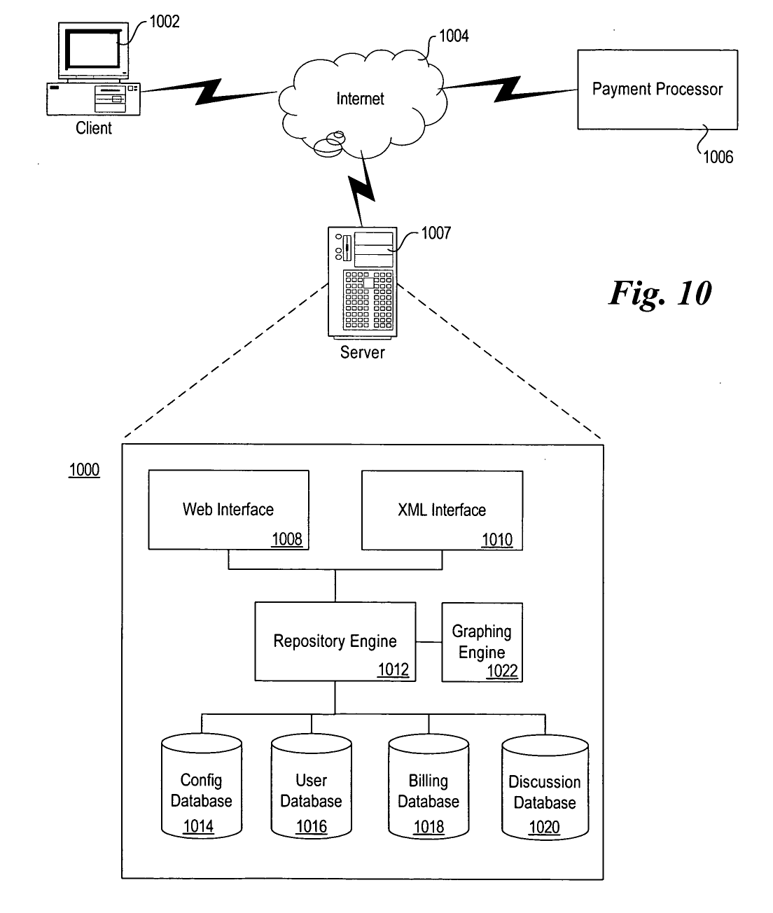

As illustrated by process flow 900 of FIG. 9, Configuration Online Service 1000 shown in FIG. 10 makes possible the storage, retrieval, viewing, and discussion of configurations over the Internet 1004, that is, the worldwide network of computer networks that use the Transmission Control Protocol/Internet Protocol (TCP/IP) to communicate. Web interface 1008 of Configuration Online Service 1000 is first browsed to by the user, using a web browser running on Client computer 1002, as shown in a block 902. If the user has an existing account on the system, as depicted by a decision block 904, the user can log in in a block 914. If not, a web interface 1008 hosted by a server 1007 directs the user through the account creation process.

The process begins in a block 906, wherein the user creates an account on the system, entering a username, with an alternate username suggested to the user if the user-entered username is already taken. The user also provides a password as well as additional information about the user, including but not limited to the user's company name, mailing address, and electronic mail address. In a block 908, web interface 1008 allows the user to configure account preferences, such as how the user will be greeted when going to the site, alternate means of accessing the site, such as via the XML interface, any groups that the user wants to participate in, and any notifications the user would like to receive, such as those indicating that a configuration has changed or been added. Web interface 1008 interacts with a repository engine 1012, a set of programs written in the Java programming language to store the user information is user database 1016.

Next, web interface 1008, interacting with billing database 1018, presents the user with billing plan options, as depicted in a block 910. These billing plans include, but are not limited to, a trial account, wherein the user may sign up to use Configuration Online Service 1000 with no charge for a specified period of time; a flat rate plan that is based on a one-time fee; a monthly subscription plan; a storage based plan that charges the user based on the amount of storage uploaded configurations take; a storage based plan based on the amount of data transferred to and from Configuration Online Service 1000; and a per-configuration plan based on the number of configurations uploaded to and downloaded from Configuration Online Service 1000. To complete the signup process, the user enters billing information, such as a credit card number, which repository engine 1012, interacting with payment processor 1006 over internet 1004 validates and charges for the selected billing plan. These operations are shown in a block 912. Once the signup process is completed, the process continues with the login process of block 914. In another embodiment, the user does not have to sign up for an account or log in prior to using Configuration Online Service 1000, continuing past block 914.

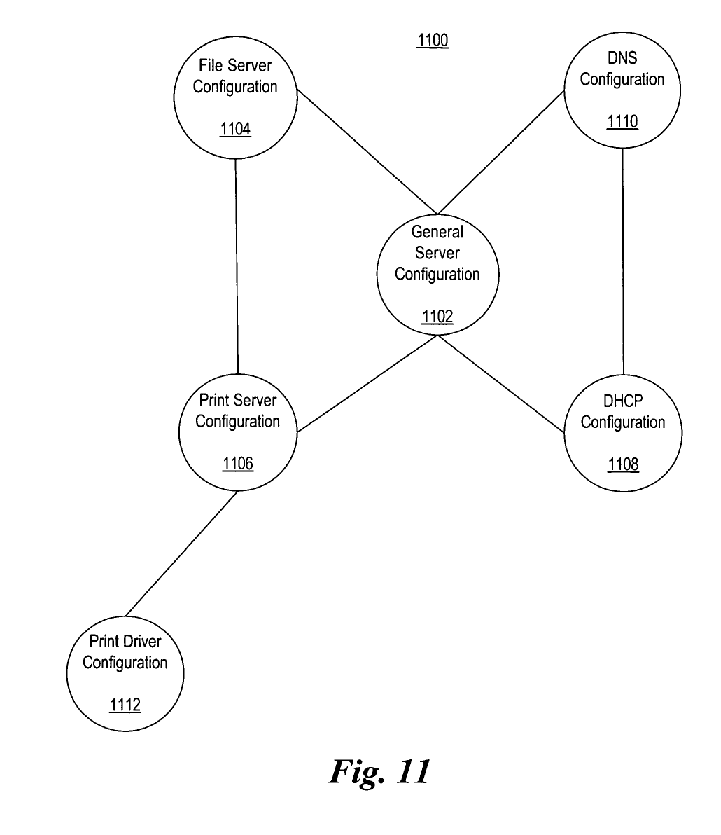

In a block 916, Configuration Online Service 1000 presents the user with the ability to browse existing configurations. During the browsing process and in accordance with a decision block 922, web interface 1008 gives the user the option to view stored configurations in a graphical format, that is, via a graphical diagram illustrating the links between various configurations. An example of this is illustrated in configuration relationship graphic 1100 in FIG. 11, which is described in more detail below. If the user does not select to have a graphical view of the configurations, web interface 1008 presents a list of configurations to the user in a block 926. If the user desires to view the configurations by group, in a block 928, Configuration Online Service 1000 allows the user to select a group by name, such as “File Server Configurations,” and then returns the configurations within that group to the user, retrieved from configuration database 1014, as depicted by a block 932.

Process 900 also allows the user to download configurations, as illustrated in a block 918. Under this operation, repository engine 1012 retrieves a user-selected configuration from configuration database 1014 and returns it to the user. In one embodiment, the configuration is returned using the Secure Sockets Layer (SSL) protocol, so that the configuration is transmitted in encrypted form to the user. In a block 919, Configuration Online Service 1000 gives the user the ability to upload a configuration; once a configuration is received by Configuration Online Service 1000, the configuration is stored in configuration database 1014, and is available for future download by the user. In a block 920, the user may enter a discussion forum provided by Configuration Online Service 1000, and stored in a Discussion Database 1020. The discussion forum provides an area for users to discuss general system administration issues and configurations stored in Configuration Online Service 1000.

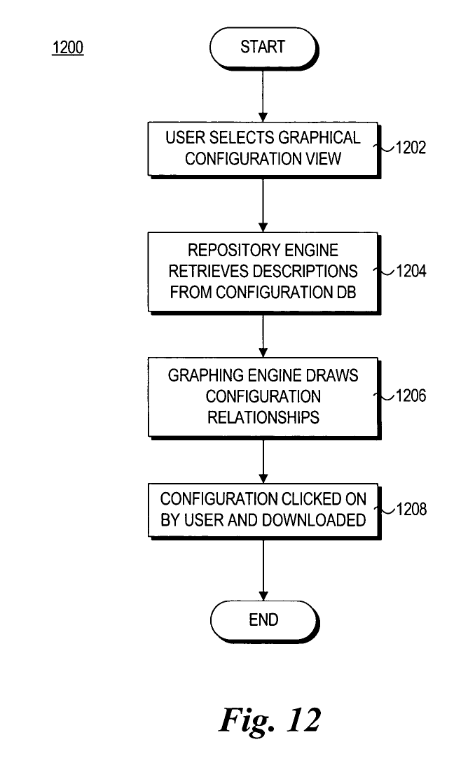

As shown in FIG. 11, in one embodiment, Configuration Online Service 1000 displays related configurations in linked tree 1100. As shown in FIG. 12, the user first selects to view a graphical representation of configurations stored in configuration database 1014, in a block 1202. Then, repository engine 1012 retrieves configuration descriptions, including, but not limited to, keywords, from configuration database 1014, a shown in a block 1204. In one embodiment, graphing engine 1022 uses a keyword matching algorithm to determine the relationships between the retrieved configuration descriptions, and thus the retrieved configurations, General Server Configuration 1102, File Server Configuration 1104, Print Server Configuration 1106, Print Driver Configuration 1112, DHCP Configuration 1108, and DNS Configuration 1110. Interfacing with web interface 1008, graphing engine 1022 then draws the configuration relationships, as shown in a block 1206. The user then clicks on a displayed configuration to download it, as shown in a block 1208.

In another embodiment, Management Snap-In 204 interfaces with XML Interface 1010, with the user interface to Configuration Online Service 1000 occurring through Snap-In 204. That is, rather than the user interacting with web interface 1008, the user interacts with Snap-In 204, which communicates with Configuration Online Service 1000 via XML interface 1010.

Exemplary Computer System for Practicing the Invention

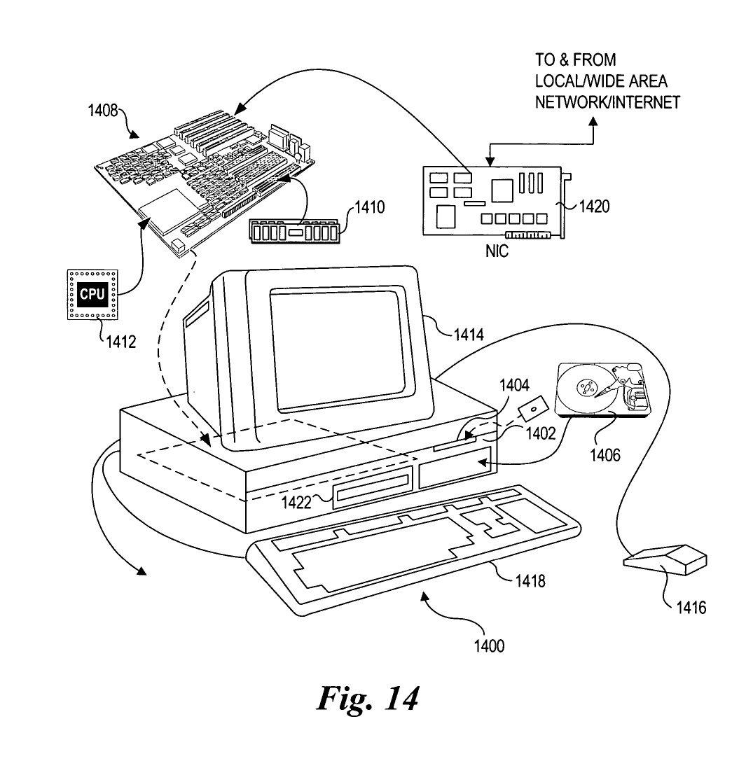

With reference to FIG. 14, a generally conventional computer 1400 is illustrated, which is suitable for use as client machines, application servers, and database servers in connection with practicing the present invention, and may be used for running client and server-side software comprising one or more software modules that implement the various operations of the invention discussed above. Examples of computers that may be suitable for client machines as discussed above include PC-class systems operating the Windows NT or Windows 2000 operating systems, Sun workstations operating the UNIX-based Solaris operating system, and various computer architectures that implement LINUX operating systems. Computer 1400 is also intended to encompass various server architectures, as well as computers having multiple processors.

Computer 1400 includes a processor chassis 1402 in which are mounted a floppy disk drive 1404, a hard drive 1406, a motherboard 1408 populated with appropriate integrated circuits including memory 1410 and one or more processors (CPUs) 1412, and a power supply (not shown), as are generally well known to those of ordinary skill in the art. It will be understood that hard drive 1406 may comprise a single unit, or multiple hard drives, and may optionally reside outside of computer 1400. A monitor 1414 is included for displaying graphics and text generated by software programs and program modules that are run by the computer. A mouse 1416 (or other pointing device) may be connected to a serial port (or to a bus port or USB port) on the rear of processor chassis 1402, and signals from mouse 1416 are conveyed to the motherboard to control a cursor on the display and to select text, menu options, and graphic components displayed on monitor 1414 by software programs and modules executing on the computer. In addition, a keyboard 1418 is coupled to the motherboard for user entry of text and commands that affect the running of software programs executing on the computer. Computer 1400 also includes a network interface card (NIC) 1420 or built-in network adapter for connecting the computer to a computer network, such as a local area network, wide area network, or the Internet.

Computer 1400 may also optionally include a compact disk-read only memory (CD-ROM) drive 1422 into which a CD-ROM disk may be inserted so that executable files and data on the disk can be read for transfer into the memory and/or into storage on hard drive 1406 of computer 1400. Other mass memory storage devices such as an optical recorded medium or DVD drive may be included. The machine instructions comprising the software that causes the CPU to implement the functions of the present invention that have been discussed above will likely be distributed on floppy disks or CD-ROMs (or other memory media) and stored in the hard drive until loaded into random access memory (RAM) for execution by the CPU. Optionally, all or a portion of the machine instructions may be loaded via a computer network as a carrier wave file.

Thus, embodiments of this invention may be used as or to support code embodied as software programs, components and/or modules executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method comprising:
installing a snap-in to run in a Microsoft Management Console (MMC) of a Microsoft Windows operating system running on Windows computer system;
retrieving configuration information, via the snap-in in the MMC, for a Linux server linked in communication with the Windows computer system via a network.

2. The method of claim 1, further comprising:
employing a daemon running on the Linux server to retrieve the configuration information for the Linux server.

3. The method of claim 1, further comprising:
displaying the configuration information in the MMC on the Windows computer system.

4. The method of claim 1, further comprising:
storing the configuration information on the Windows computer system.

5. The method of claim 4, further comprising:
deploying the configuration information on another Linux server.

6. The method of claim 4, further comprising:
enabling a user to change the configuration information that is stored.

7. The method of claim 6, further comprising:
deploying configuration information that is changed on another Linux server.

8. The method of claim 4, wherein the configuration information is stored in an Extensible Markup Language (XML) form.

9. The method of claim 4, further comprising:
retrieving configuration information from multiple Linux servers via the snap-in; and
storing respective sets of configuration information for each Linux server.

10. The method of claim 1, further comprising:
enabling the configuration information to be accessed via the Internet using a web browser.

11. The method of claim 9, further comprising:
enabling the configuration information to be changed via the web browser.
